(19) United States
(12) Patent Application Publication
(10) Pub. No.: US 2026/0149282 A1
(43) Pub. Date: May 28, 2026

(54) VEHICLE-TO-EVERYTHING METHODS AND APPARATUSES, INCLUDING VEHICLE-TO-HOME FUNCTIONALITY

(71) Applicant: Atieva, Inc., Newark, CA (US)

(72) Inventors: Shan Chai, Newark, CA (US); Dung Anh Nguyen, Newark, CA (US); Beomseok Lee, Newark, CA (US); Seyed Amir Assadi, Newark, CA (US); Shantanu Gupta, Newark, CA (US); Vinson Jones, Newark, CA (US); Antony Martin, Newark, CA (US)

(21) Appl. No.: 19/397,626

(22) Filed: Nov. 21, 2025

Related U.S. Application Data
(60) Provisional application No. 63/724,250, filed on Nov. 22, 2024.

(51) Int. Cl. H02J 3/32; B60L 53/16; B60L 53/18; B60L 55/00

(52) U.S. Cl. CPC H02J 3/322; B60L 53/16; B60L 53/18; B60L 55/00

(57) ABSTRACT

Apparatuses, methods and automobiles (e.g., electric vehicles (EV), etc.) that send power from their energy storage to an electrical to a home are disclosed. In some embodiments, an electric vehicle (EV) includes: an energy storage; a device to send power from the energy storage to a building, to one or more other vehicles and/or to a load; on-board communication hardware; and one or more processors to control transfer of power with the building.

### RELATED APPLICATION

The present application is a non-provisional application of and claims the benefit of U.S. Provisional Ser. No. 63/724,250 , filed Nov. 22, 2024, and entitled “VEHICLE-TO-EVERYTHING METHODS AND APPARATUSES”, which is incorporated by reference in its entirety.

### FIELD OF THE INVENTION

Embodiments disclosed herein relate generally to automobiles, and more particularly, automobiles that send power from their energy storage to an electrical power grid, to a home, to one or more other vehicles and/or to a load to vehicle-to-home for an electric vehicle (EV).

### BACKGROUND

Electric vehicles (EVs) offer a promising alternative to traditional combustion engine vehicles and often integrate smart technology and safety features into their designs. EVs are often charged though an electric vehicle supply equipment (EVSE) charger that provides power to the EV. When an EV is plugged into the EVSE, there's a communication process before charging begins. For example, the EVSE communicates with the EV to determine the amount of power it can provide and then requests an amount of power to be provided that the EV can accept. The power that is provided via the EVSE is usually from an electric utility grid under control of an electric utility company and is done via a process that follows one or more standards.

### SUMMARY

Apparatuses, methods and automobiles (e.g., electric vehicles (EV), etc.) that send power from their energy storage to an electrical to a home are disclosed. In some embodiments, an electric vehicle (EV) includes: an energy storage; a device to send power from the energy storage to a building, to one or more other vehicles and/or to a load; on-board communication hardware; and one or more processors to control transfer of power with the building.

Other aspects and advantages of the embodiments will become apparent from the following detailed description taken in conjunction with the accompanying drawings which illustrate, by way of example, the principles of the embodiments described.

### BRIEF DESCRIPTION OF THE DRAWINGS

The embodiments described and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 illustrates some embodiments of a vehicle-to-everything (V2X) power transfer framework.

FIGS. 2A and 2B illustrate some embodiments of an architecture of a vehicle-to-home (V2H) connection using a system in North America and a system in Europe, respectively.

FIGS. 3A and 3B illustrate some embodiments of a cable and electric vehicle (EV) interface to accommodate V2H in North American markets in comparison to a standard North American Charging Standard (NACS) cable-EV interface.

FIG. 4 is a high-level view of some embodiments of a vehicle.

FIG. 5 is a high-level illustration of an exemplary computing device that can be used in accordance with the systems and methodologies disclosed herein.

### DETAILED DESCRIPTION

In the following description, numerous details are set forth to provide a more thorough explanation of embodiments of the present disclosure. It will be apparent, however, to one skilled in the art, that the teachings disclosed herein may be practiced without these specific details. In other instances, well-known structures and devices are shown in block diagram form, rather than in detail, in order to avoid obscuring the present disclosure.

Apparatuses and methods for implementing vehicle-to-everything (V2X) technology are disclosed. In some embodiments, the V2X technology includes vehicle-to-home (V2H) functionality. The V2H functionality can enable an EV to provide power to a home or other building. In some embodiments, the V2H functionality enables a V2H solution in which multiple vehicles can provide power to the home.

### Enabling Electric Vehicles as Distributed Energy Resources

Vehicle-to-everything (V2X) technology is disclosed herein. In some embodiments, V2X technologies enable the use of electric vehicles (EVs) as crucial Distributed Energy Resources (DERs) in the evolving energy landscape. To facilitate this usage, in some embodiments, the V2X technology uses an AC bidirectional onboard charging system in the EV. In some embodiments, the V2X technology supports advanced V2X capabilities, such as, but not limited to, vehicle-to-grid (V2G) (allowing EVs to supply power back to the grid), vehicle-to-home (V2H) (using EV batteries to power homes during outages or peak demand periods), vehicle-to-load (V2L) (using EV batteries to power a load during outages or peak demand periods, and vehicle-to-vehicle (V2V) (enabling power transfer between EVs). In some embodiments, these technologies enable the use of the EV battery capacity and its utilization when vehicles are parked and unused for more than 95% of their lifetime.

In some embodiment, the AC bidirectional charging system offers AC bidirectional charging capabilities with up to 19.2 kW discharge power. This capability significantly reduces overall cost compared to DC systems, which require more components and a dual inverter setup. In some embodiments, the V2X technology and its use of the AC bidirectional charging system reduces cost by component optimization (e.g., the on-board bidirectional charger design is refined to reduce, and potentially minimize, redundant components, reduce material costs and improve manufacturing efficiency), integration improvements (e.g., integration with existing vehicle power electronics is enhanced to reduce, and potentially minimize, redundant components), software advancements (e.g., sophisticated control algorithms for maximum efficiency and lifespan), and through standardization of interface and protocols.

In some embodiments, the V2X technology and its AC bidirectional charging system includes a number of features. In some embodiments, the technology implements software control algorithms, such as ZVS, ZCS, and Deadband control to optimize power utilization across all V2X features. This can result in optimized power conversion efficiency. In some embodiments, the technology includes DC-coupled V2V charging without extra AC/DC conversion, based on common topology with bidirectional AC and DC capabilities and an on-board charger (OBC) to generate neutral line voltage for split-phase systems, which enables V2H without external Neutral Forming Transformer (NFT) devices and drive the cost efficiency and cost of attainment.

In some embodiments, the V2X technology includes standardized communication. In some embodiments, the standardized communication implements LIN (Local Interconnect Network)-Control Pilot (CP), as a frequency-based CP for V2X applications to reduce wiring complexity and improve charging efficiency while adopting the industry standard protocol for V2X vertical integration and foster cross platform/OEM V2X system.

In some embodiments, the V2X technology includes advanced power electronics. These power electronics include an on-board charger (OBC) that utilizes GaN-based power switches for higher frequency operation, resulting in lower mass components and higher power density, and single-stage converters and other advanced power electronics topologies to lower bill of materials (BOM) costs and increase system efficiency.

In various embodiments, the V2X technology provides one or more benefits. For example, the V2X technology reduces peak demand in that the EVs can supply power back to the grid during high-demand periods, flattening the demand curve and reducing strain on electrical infrastructure, provides enhanced grid stability in that the distributed EV batteries provide rapid response to grid fluctuations, improving overall stability and reliability, lowers electricity costs by optimizing EV charging and discharging to take advantage of time-of-use rates, reducing consumer electricity bills, defers infrastructure upgrades by potentially delay grid infrastructure upgrades by reducing the coincidental peak and increasing the life of the equipment, and increases renewable energy integration by helping to balance intermittent renewable energy sources, facilitating higher clean energy penetration in the grid.

In some embodiments, the AC V2H approach offers several safety advantages, including, but not limited to, simplified hardware (e.g., the AC system requires fewer components compared to DC systems, reducing potential points of failure), integrated protection (e.g., the vehicle's on-board charger includes built-in safety features, ensuring protection for both the vehicle and the grid), and standardized interfaces (e.g., utilization of standard AC connections reduces, and potentially minimizes, incompatibility risks and improves overall safety).

In some embodiments, the V2X includes a cloud-based infrastructure and communication system. In some embodiments, the cloud-based infrastructure implements a cloud-based global optimization algorithm that considers grid utility tariffs, dynamic pricing, renewable energy generation, etc. ; vehicle conditions (e.g., state of charge, etc.); and overall system efficiency. This approach enables more effective load balancing and grid support while optimizing benefits for individual vehicle owners.

The V2X technology disclosed herein will specifically address the needs of low-income owners by: enabling vehicles to function as mobile power walls, providing backup power for households, facilitating power donation to community power walls, lowering utility prices through vehicle-to-grid (V2G) participation, and reducing overall vehicle costs through lower-cost components, improving affordability.

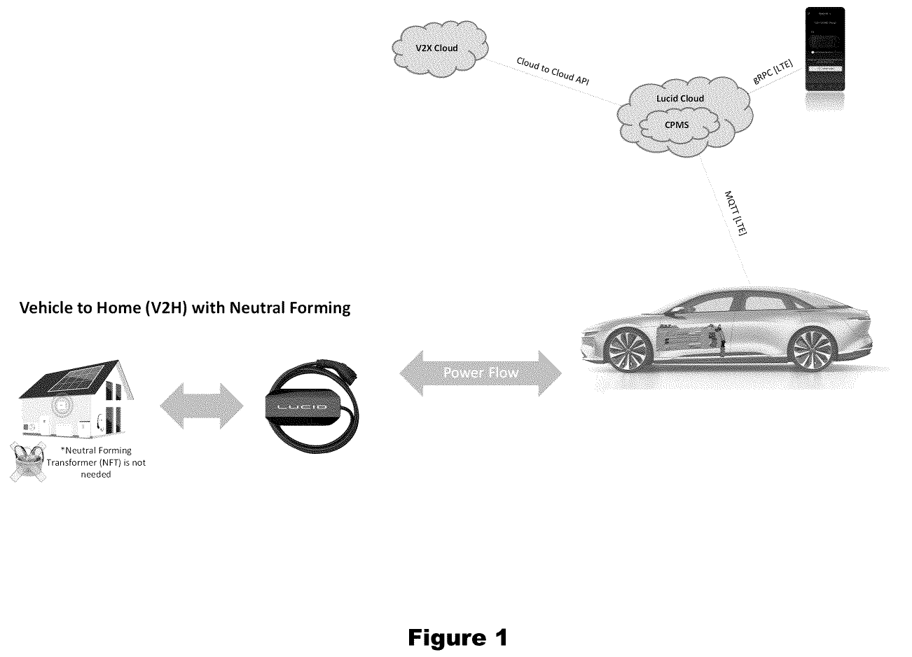

FIG. 1 illustrates some embodiments of a vehicle-to-everything (V2X) power transfer framework. Referring to FIG. 1, a vehicle can exchange power with one or more other vehicles. In some embodiments, the power flow in this exchange of power is a Higher Power RangeXchange (DC V2V) and the transfer of power is a DC power transfer that does not require an AC conversion. That is, the DC power is transferred between the vehicles without both vehicles performing an AC conversion. The use of these types of cables can enable a power transfer directly to the battery of the vehicle. Note that the donor vehicle that is providing the power in such a power transfer may have to perform a DC-to-DC power conversion, but a conversion between DC and AC is still not needed. In some embodiments, the transfer of power is further simplified by using a NACS cable without an EV charger (e.g., without an EVSE involved in the transfer). Alternatively, a CCS1-CCS1 cable could be used. In such a case, an EV charger would not be required for the power transfer.

In some embodiments, the vehicle can exchange power with a home. In some embodiments, the power flow can be between the vehicle and the home. In some embodiments, the transfer of power is a vehicle-to-home (V2H) power transfer with neutral forming. In other words, a neutral forming transformer (NFT) is not needed.

In some embodiments, the vehicle communicates with one or more clouds using cloud-based communication. For example, in the case of vehicles manufactured and/or sold by Lucid Motors, the vehicle can communicate with the Lucid Motors cloud network. In some embodiments, these communications occur via one or more protocols (e.g., a messaging/queuing platform (e.g., MQTT, etc.). Other forms of wireless communications and/or protocols can be used. In some embodiments, such communications can involve communications with a V2X cloud that manages the power transfers disclosed herein. This can involve cloud-to-cloud communication between the Lucid Motors cloud and the V2X cloud. In some embodiments, one or more mobile devices can communicate with the Lucid Motors cloud to facilitate communication involving the vehicle. In some embodiments, these communications occur using a gRPC protocol, though other protocols could be used.

In some embodiments, the communication with the V2X cloud facilitates fleet level operations that further support the V2X. The V2X cloud can receive information regarding the fleet of vehicles in the communication network and make decisions and cause operations to be performed regarding the V2X power transfers disclosed herein. In some embodiments, these decisions can be made to ensure that the power transfers occur in harmony with the electrical grid and/or for improving (e.g., optimizing) efficiency. For example, the V2X cloud may know the different battery voltage levels of the vehicles in the fleet and can decide to charge a vehicle using the most efficient way possible (e.g., from the best (or a better) vehicle from which to be charged, from a home, etc.).

### Vehicle-to-Home (V2H) Methods and Apparatus

In some embodiments, the V2X technology includes vehicle-to-home (V2H) functionality that allows power to be sent from one or more vehicles to the home (or other building (e.g., dwelling, etc.)). In some embodiments, the EV includes both hardware and software components to enable V2H operation from the EV without the need for a neutral forming transformer. In some embodiments, the V2H functionality uses an on-board charger (OBC) that converts AC power from the grid into DC power to charge the car's high-voltage battery and that can operate in any grid region around the world (e.g., works with three-phase grid connections and single-phase AC connections like split-phase connections).

In some embodiments, the V2H functionality includes three components:
1. A controls and topology selection that commonizes the EV V2H capability for both single phase and three phase grids;
2. Functionality to connect with full V2H operation without the need for a neutral forming transformer; and
3. A cable-EV interface capable of V2H operation that carries a communication protocol on the existing Control Pilot (CP) line to enable the intercommunication of multiple vehicles on the same bus to facilitate a multi-EV connection on one AC bus.

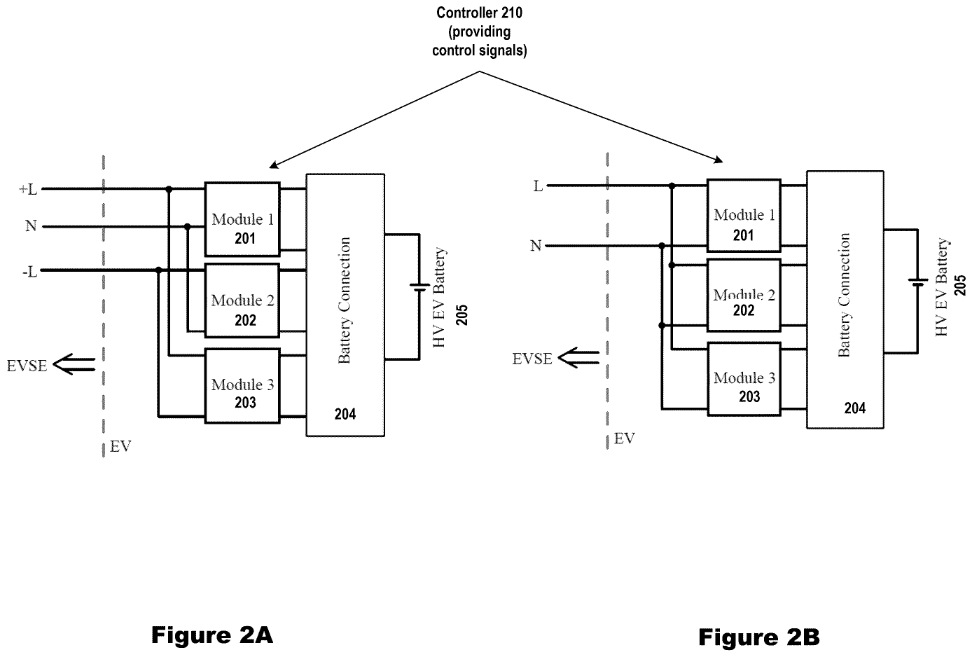

FIGS. 2A and 2B illustrate some embodiments of an architecture of a V2H connection using a system in North America and a system in Europe, respectively. Referring to FIGS. 2A and 2B, the customized controls and topology for single and three-phase grids include an OBC having three separate modules 201-203 that can be controlled. Modules 201-203 are coupled to EV battery 205 via a battery connection 204. The architectures in FIGS. 2A and 2B are shown relative to EVSE (via a dashed line). In some embodiments, modules 201-203 and the battery connection 204 contain switched power electronics. These boxes could take the shape of different circuits with a different number of switches (and other components). In some embodiments, either of battery connection 204 or modules 201-203 also contain a form of galvanic isolation.

In some embodiments, each of modules 201-203 is controlled separately, while in some other embodiments, modules 201-203 are controlled using one centralized controller. Modules 201-203 can be configured in different configurations to achieve V2H connection for either single-phase or three-phase locations. To that end, the EV has V2H functionality for neutral forming. Because the EV performs neutral forming, the home does not have to have a neutral forming transformer (NFT). With respect to controls for forming neutral, in some embodiments, the three modules are controlled with two different references. In the configuration shown in FIG. 2A, module 201 and module 202 operate to implement a split phase connection (by having module 201 coupled to the positive line (+L) and neutral line (N) and module 202 coupled to the neutral line (N) and the negative line (−L)), while module 203 operates to provide power while connected to the positive line (+L) and negative line (−L) connections. In contrast, in FIG. 2B, each of modules 201-203 is connected to line (L) and neutral (N) connections. Thus, both configurations of modules 201-203 include a hard neutral connection (even though US households require split-output of 120V and the single phase European households are limited to 120V).

In some embodiments, switching between the two configurations in FIGS. 2A and 2B is performed in response to control signals from controller 210 and using reconfiguration relays (not shown but implied by the connection wires that are drawn to the left of modules 201-203). In some embodiments, the reconfiguration relays allow a single implementation to support both configurations in FIGS. 2A and 2B by being able to switch between the configurations based on the location of the EV (e.g., a home in North America or a home in Europe) and/or the grid to which the EV is connected. In some embodiments, the EV can receive a notification of which configuration it should be using and will configure itself appropriately. This notification can be sent wirelessly (e.g., via a cloud communication, etc.) or set in a vehicle configuration (e.g., vehicle configuration at a manufacturing facility, etc.). In some alternative embodiments, the EV can measure the voltage on the other side of the relays (e.g., the EVSE side) and use those measurements to determine in which configuration the EV should be.

In some embodiments, modules 201-203 in the OBC are connected in a split-phase configuration such as shown in FIG. 2A. For example, in such a case, the positive line +L can have a positive 120V (a sinusoidal AC voltage waveform), while the negative line −L can have a negative 120V (e.g., an opposite sinusoidal AC voltage waveform), and module 203 would have a voltage across both +l and −L lines of 240V. Note that these voltages are merely examples to show the operation of modules 201-203, and other voltages can be used based on the region in which the vehicle is operating. In some other embodiments, the vehicle can obtain this voltage information from the EVSE.

By being able to connect all three modules 201-203 in the OBC to a split-phase configuration, a higher or full power of the OBC can be leveraged in V2H mode in North American markets, in comparison to systems using only two modules of modules 201-203. More specifically, in some embodiments, the current limit of each of modules 201-203 does not allow for full power operation at single phase voltages. In such a case, the use of a third module of modules 201-203 (e.g., module 203) increases the full rating of the V2H functionality. For example, in some embodiments, modules 201-203 have a 16 A rating. In such a case, with only two modules being used, 3.84 kW (assuming a 120V) will be available from the EV OBC; however, with all of modules 201-203, 7.68 kW will be available from the EV OBC. Thus, in other words, in some embodiments, modules 201 and 202 implement a split neutral while module 203 provides added power.

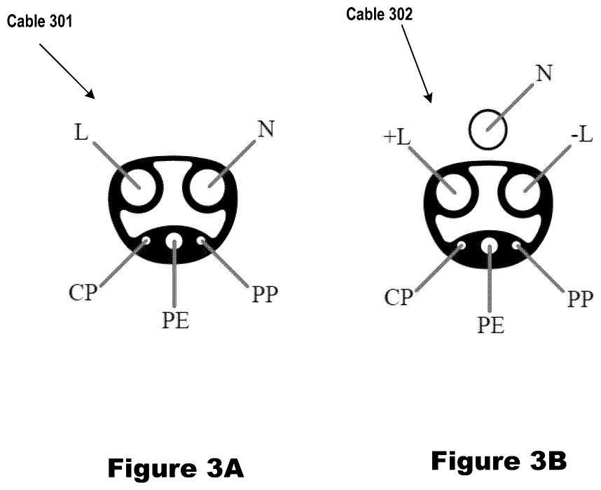

FIGS. 3A and 3B illustrate a cable and EV interface to accommodate V2H in North American markets in comparison to a standard NACS cable-EV interface. More specifically, FIG. 3A illustrates a standard NACS cable-EV interface (with cable 301) having an interface that includes Line (L), Neutral line (N), control pilot (CP) line, protective earth (PE) (ground) line, and proximity pilot (PP) line. FIG. 3B illustrates some embodiments of a cable and EV interface to accommodate V2H (with cable 302) having an interface with positive line (+L) and negative line (−L), N line, CP line, PE line, and PP line.

The cable-EV interface in FIG. 3B can connect to the neutral power rail of the OBC at the EV charge port connection and allows for the neutral connection to carry power from the OBC to the EVSE. In some embodiments, the N line connection can be connected with a separate, individual cable between the EV and the home, such as shown in FIG. 3B. The N line connection can be a new outlet in proximity (e.g., on top of, etc.) the normal bi-directional charging outlet of the EV. This connection will be in addition to the connections required by the NACS standard and does not interfere with the normal operation of the cable during the EV's energy storage charging process. In other words, for regular charging of the EV, no connection needs to be made with the N line and a regular charging connection using the NACS interface can be used to change the EV (without an N line connection).

In some embodiments, the cable-EV interface uses a form of communication over the CP line that allows for the communication of multiple EVs on one communication bus. The communication can be among the EVs to facilitate interaction with, and providing power to, the home. This form of communication is in essence free as the CP line is available for communication and can be accessed by the multiple EVs during a multiple vehicle V2H application in which multiple vehicles are providing power to the home (e.g., multiple vehicles provide power to a home one at a time, multiple vehicles provide power to a home at the same time). The communication can involve dynamic negotiation between the EVs to be either a grid former or follower depending on the application. For example, when multiple EVs are connected to the home, communication can enable one EV to negotiate to be a grid former, while the others are followers. For example, when multiple EVs are connected to a single location (e.g., a hub, etc.) in a home, communication between the EVs can occur over the CP line, and by negotiation among the EVs, one can become a grid former (e.g., a power discharger to the home) and the others can be followers. If one of the EVs departs, a re-negotiation can occur amount the EVs without an effect on the home. For example, if the EV acting as the grid former departs, then one of the remaining EVs can take over being the grid former (and discharge their power to the home).

While the communication to the home for multiple EVs can be through a common location (e.g., hub), in some embodiments, the communication is done separately through their individual chargers. In this case, both could communicate to the home via their cable (e.g., via their CP line of the cable interface) and the communication with each other would occur through a common location in the home to which all of the EV's CP lines are communicably coupled together. In some alternative embodiments, multiple EVs use a bus such as a dedicated cable interface, between each other to communicate when determining which EV is to interface and be the grid former for the home.

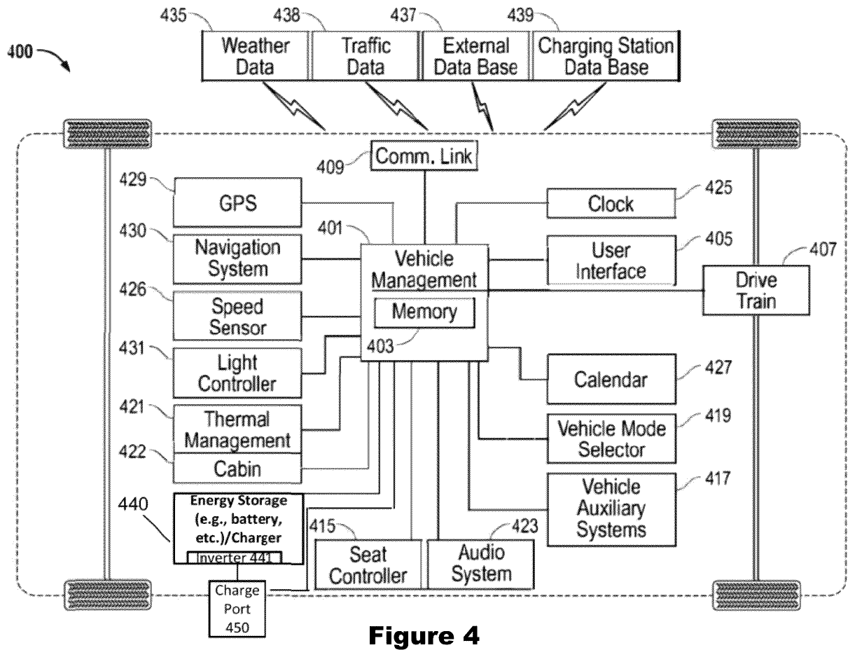

FIG. 4 is a high-level view of some embodiments of a vehicle 400. Vehicle 400 can be an electric vehicle (EV), a vehicle utilizing an internal combustion engine (ICE), or a hybrid vehicle, where a hybrid vehicle utilizes multiple sources of propulsion including an electric drive system. Vehicle 400 includes a vehicle on-board system controller 401, also referred to herein as a vehicle management system, which is comprised of one or more processors (e.g., a central processing unit (CPU)). System controller 401 also includes memory 403, with memory 403 being comprised of EPROM, EEPROM, flash memory, RAM, solid state drive, hard disk drive, or any other type of memory or combination of memory types.

In some embodiments, vehicle 400 includes one or more internal networks by which system controller 401 interfaces and communicates with one or more internal subsystems of vehicle 400. System controller 401 can also use the one or more internal networks to transfer communications to and from external locations. In some embodiments, the one or more internal networks can be communicably coupled to one or more networks through a network interface. The network interface can provide for wired and/or wireless communication. When used in a local area networking environment (or a wide area networking environment), the network interface can include an Ethernet interface and the one or more internal networks (e.g., an Ethernet communication network (e.g., an Ethernet Ring, etc.) with an Ethernet Port). Other possible embodiments use other communication devices. For example, in some embodiments, vehicle 400 includes a modem for communicating across an internal network and/or with an external network.

In some embodiments, vehicle 400 includes a charging port 450 and one or more batteries (e.g., battery pack, etc.)/battery charger as an energy storage system 440 that provides power to portions of vehicle 400. The charging port 450 is used for providing voltage to vehicle 400 for charging the energy storage system 440 (e.g., charging batteries of batteries/charger by use of, for example, an EVSE or other power source in a manner well-known in the art. The charging port 450 can be used to transfer power from a battery of the energy storage system 440 to an external location as part of a vehicle-to-grid power transfer. In some embodiments, charging port 450 includes a communication path for communications between the system controller 401 and the locations external to vehicle 400 such as, for example, the power source providing power (voltage) to vehicle 400 for charging batteries of the energy storage system 440 and a utility distributed energy resource management system (DERMS) or an electric utility company and its facilities. In some embodiments, vehicle 400 includes an on-board charger as described above.

In some embodiments, energy storage system 440 includes an inverter 441 that generates voltage for transfer to an electric power grid. In some embodiments, the inverter 441 converts DC voltage to AC voltage for transfer to the electric power grid. In some embodiments, such an inverter is part of a vehicle-to-grid (V2G) solution that is used by vehicle 400 is described in U.S. patent application Ser. No. 18/590,832, entitled VEHICLE-TO-GRID COMMUNICATION COMPLIANCE FOR ELECTRIC VEHICLES, filed February 28, 2024, and is incorporated herein by reference. In some embodiments, the same inverter (or a separate invertor) converts DC voltage to AC voltage for charging a battery of the energy storage system 440 or can provide DC to AC voltage conversion when providing power to an electrical power grid as part of a vehicle-to-grid operation.

In some embodiments, vehicle 400 with its energy storage system 440 is able to interface with a NACS cable (or CCS1-CCS1 cable) to enable power flow to other vehicles.

In some embodiments, vehicle 400 includes a user interface 405 coupled with vehicle management system 401. Interface 405 allows the driver, or a passenger, to interact with the vehicle management system, for example inputting data into the navigation system 430, altering the heating, ventilation and air conditioning (HVAC) system via the thermal management system 421, controlling the vehicle's entertainment system (e.g., radio, CD/DVD player, etc.), adjusting vehicle settings (e.g., seat positions, light controls, etc.), and/or otherwise altering the functionality of vehicle 400. In some embodiments, user interface 405 also includes means for the vehicle management system to provide information to the driver and/or passenger, information such as a navigation map or driving instructions (e.g., via the navigation system 430 and GPS system 429) as well as the operating performance of any of a variety of vehicle systems (e.g., battery pack charge level for an EV, fuel level for an ICE-based or hybrid vehicle, selected gear, current entertainment system settings such as volume level and selected track information, external light settings, current vehicle speed (e.g., via speed sensor 426), current HVAC settings such as cabin temperature and/or fan settings, etc.) via the thermal management system 421. Interface 405 may also be used to warn the driver of a vehicle condition (e.g., low battery charge level or low fuel level) and/or communicate an operating system malfunction (battery system not charging properly, low oil pressure for an ICE-based vehicle, low tire air pressure, etc.). Vehicle 400 can also include other features like an internal clock 425 and a calendar 427.

In some embodiments, user interface 405 includes one or more interfaces including, for example, a front dashboard display (e.g., a cockpit display, etc.), a touch-screen display (e.g., a pilot panel, etc.), as well as a combination of various other user interfaces such as push-button switches, capacitive controls, capacitive switches, slide or toggle switches, gauges, display screens, warning lights, audible warning signals, etc. It should be appreciated that if user interface 405 includes a graphical display, controller 401 may also include a graphical processing unit (GPU), with the GPU being either separate from or contained on the same chip set as the processor.

Vehicle 400 also includes a drive train 407 that can include an internal combustion engine, one or more motors, or a combination of both. The vehicle's drive system can be mechanically coupled to the front axle/wheels, the rear axle/wheels, or both, and may utilize any of a variety of transmission types (e.g., single speed, multi-speed) and differential types (e.g., open, locked, limited slip).

Drivers often alter various vehicle settings, either when they first enter the car or while driving, in order to vary the car to match their physical characteristics, their driving style and/or their environmental preferences. System controller 401 monitors various vehicle functions that the driver may use to enhance the fit of the car to their own physical characteristics, such as seat position (e.g., seat position, seat height, seatback incline, lumbar support, seat cushion angle and seat cushion length) using seat controller 415 and steering wheel position using an auxiliary vehicle system controller 417. In some embodiments, system controller 401 also can monitor a driving mode selector 419 which is used to control performance characteristics of the vehicle (e.g., economy, sport, normal). In some embodiments, system controller 401 can also monitor suspension characteristics using auxiliary vehicle system 417, assuming that the suspension is user adjustable. In some embodiments, system controller 401 also monitors those aspects of the vehicle which are often varied by the user in order to match his or her environmental preferences for the cabin 422, for example setting the thermostat temperature or the recirculation controls of the thermal management system 421 that uses an HVAC controller, and/or setting the radio station/volume level of the audio system using controller 423, and/or setting the lights, either internal lighting or external lighting, using light controller 431. Also, besides using user-input and on-board sensors, system controller 401 can also use data received from an external on-line source that is coupled to the controller via communication link 409 (using, for example, GSM, EDGE, UMTS, CDMA, DECT, WiFi, WiMax, etc.). For example, in some embodiments, system controller 401 can receive weather information using an on-line weather service 435 or an on-line data base 437, traffic data 438 for traffic conditions for the navigation system 430, charging station locations from a charging station database 439, etc. In some embodiments, communication link 409 comprises an Ethernet communication link with an Ethernet Port for external communications.

The system controller 401 can transfer information with the components described above over one or more internal networks, such as those, for example, described above. In some embodiments, the system controller 401 is communicably coupled to one or more of these components via an Ethernet communication network (e.g., an Ethernet Ring, etc.). The Ethernet communication network can be used to transfer other data such as data related to, but not limited to, one or more of a driver-assistance system, telematics, over-the-air updates, etc.

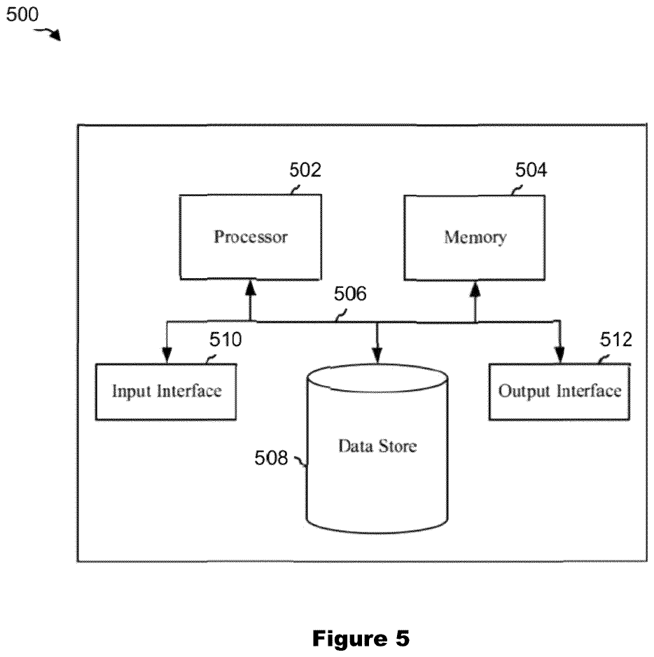

FIG. 5 is a high-level illustration of an exemplary computing device 500 that can be used in accordance with the systems and methodologies disclosed herein. For instance, the computing device 500 may be or include the vehicle 400 of FIG. 4. The computing device 500 includes at least one processor 502 that executes instructions that are stored in a memory 504. The instructions may be, for instance, instructions for implementing functionality described as being carried out by one or more modules or instructions for implementing one or more of the methods described above. The processor 502 may access the memory 504 by way of a system bus 506.

The computing device 500 additionally includes a data store 508 that is accessible by the processor 502 by way of the system bus 506. The data store 508 may include executable instructions and the like. The computing device 500 also includes an input interface 510 that allows external devices to communicate with the computing device 500. For instance, the input interface 510 may be used to receive instructions from an external computing device, from a user, etc. The computing device 500 also includes an output interface 512 that interfaces the computing device 500 with one or more external devices. In some embodiments, the input interface 510 and the output interface 512 can be used to communicate to an electric utility company (e.g., a utility distributed energy resource management system (DERMS) or server, etc.). These communications can relate to vehicle-to-grid and/or standards as described above. In some other embodiment, the input interface 510 and the output interface 512 can be used to communicate with a home, vehicle or a load for vehicle-to-home, to-vehicle, and to-load operations and the transfers of power and power flow between each. In some embodiments, the input interface 510 and the output interface 512 are part of, or communicably coupled to, an Ethernet port of an Ethernet communication network (e.g., an Ethernet Ring, etc.).

Additionally, while illustrated as a single system, it is to be understood that the computing device 500 may be a distributed system. Thus, for instance, several devices may be in communication by way of a network connection and may collectively perform tasks described as being performed by the computing device 500.

All of the methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some embodiments, the computer system may be a cloud-based computing system whose processing resources are shared by multiple distinct business entities or other users.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in some embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware (e.g., ASICs or FPGA devices), computer software that runs on computer hardware, or combinations of both. Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the rendering techniques described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, or steps. Thus, such conditional language is not generally intended to imply that features, elements, or steps are in any way required for one or more embodiments or that one or more embodiments necessarily include logic for deciding, with or without other input or prompting, whether these features, elements or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y, and at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

We claim:

1. An electric vehicle (EV) comprising:
an energy storage;
a device to send power from the energy storage to a building, to one or more other vehicles and/or to a load;
on-board communication hardware; and
one or more processors to control transfer of power with the building.

2. The EV of claim 1 wherein the building is a home.

3. The EV of claim 1 wherein the device comprises an on-board charger (OBC).

4. The EV of claim 1 wherein the device comprises a plurality of modules reconfigurable to provide power to connect to single, split or three phase grid.

5. The EV of claim 4 wherein the plurality of modules comprises first, second and third modules, with two of the plurality of modules being configurable to implement a split phase connection and a third module of the plurality of modules configured to provide power to positive line (+L) and negative line (−L) connections.

6. The EV of claim 4 wherein the plurality of modules comprises first, second and third modules, and further wherein when configured to provide power to a three phase grid, the first module has connections to a positive line (+L) and a neutral line (N), the second module has connections to the neutral line (N) and the negative line (−L), and the third module has connections to the positive line (+L) and the negative line (−L).

7. The EV of claim 4 wherein the plurality of modules comprises first, second and third modules, and further wherein when configured to provide power to a single-phase grid, the first, second and third modules have connections to a line (L) and a neutral line (N).

8. The EV of claim 1 wherein the device comprises an OBC having a neutral power rail and a charge port having a cable and EV interface for connecting the neutral power rail at the charge port for power transfer from the OBC to the building.

9. The EV of claim 8 wherein the cable and EV interface includes a control pilot (CP) line, the CP line to carry communications between the EV and at least one other EV when multiple EVs to communicate with each other.

10. The EV of claim 9 wherein communications on the CP line relate to negotiation related to which of the multiple EVs is to be a grid former or follower.

11. An electric vehicle (EV) comprising:
an energy storage;
a device to send power from the energy storage to an electrical power grid, to a home, to one or more other vehicles and/or to a load;
on-board communication hardware; and
one or more processors to control transfer of power with the electrical power grid, the home, one or more other vehicles and/or the load.

12. The EV of claim 11 wherein the device comprises an on-board charger (OBC).

13. The EV of claim 12 wherein the OBC comprises an inverter to convert DC power from the energy storage to AC power to be sent from the energy storage from the EV.

14. The EV of claim 11 wherein the device comprises a plurality of modules reconfigurable to provide power to single, split or three phase grid.

15. The EV of claim 14 wherein the plurality of modules comprises first, second and third modules, with two of the plurality of modules being configurable to implement a split phase connection and a third module of the plurality of modules configured to provide power to positive line (+L) and negative line (−L) connections.

16. The EV of claim 14 wherein the plurality of modules comprises first, second and third modules, and further wherein when configured to provide power to a three phase grid, the first module has connections to a positive line (+L) and a neutral line (N), the second module has connections to the neutral line (N) and the negative line (−L), and the third module has connections to the positive line (+L) and the negative line (−L).

17. The EV of claim 14 wherein the plurality of modules comprises first, second and third modules, and further wherein when configured to provide power to a single-phase grid, the first, second and third modules have connections to a line (L) and a neutral line (N).

18. The EV of claim 11 wherein the device comprises an OBC having a neutral power rail and a charge port having a cable and EV interface for connecting the neutral power rail at the charge port for power transfer from the OBC to the building.

19. The EV of claim 18 wherein the cable and EV interface includes a control pilot (CP) line, the CP line to carry communications between the EV and at least one other EV when multiple EVs to communicate with each other.

20. The EV of claim 19 wherein communications on the CP line relate to negotiation related to which of the multiple EVs is to be a grid former or follower.
